(19) United States
(12) Patent Application Publication
(10) Pub. No.: US 2017/0230091 A1
(43) Pub. Date: Aug. 10, 2017

(54) METHOD AND APPARATUS FOR DETERMINING CODEBOOK AND COMMUNICATION SYSTEM

(71) Applicant: FUJITSU LIMITED, Kawasaki-shi (JP)

(72) Inventors: Lei SONG, Beijing (CN); Xin WANG, Beijing (CN); Yi LIANG, Beijing (CN)

(73) Assignee: FUJITSU LIMITED, Kawasaki-shi (JP)

(21) Appl. No.: 15/499,184

(22) Filed: Apr. 27, 2017

Related U.S. Application Data
(63) Continuation of application No. PCT/CN2014/089801, filed on Oct. 29, 2014.

(51) Int. Cl. H04B 7/04; H04B 7/10

(52) U.S. Cl. CPC H04B 7/0469; H04B 7/10

(57) ABSTRACT

A method and apparatus for determining a codebook and a communication system includes: determining a first codebook used for radio frequency precoding on the basis of the number of the antenna elements in the planar antenna array and/or the number of radio frequency chains; wherein, the antenna elements in the same polarization direction in an antenna column in the vertical direction form one or more virtual antenna ports, which are being connected with multiple radio frequency chains; and determining a second codebook used for baseband precoding on the basis of the number of the antenna elements in the planar antenna array and/or the number of the radio frequency chains. With certain embodiments, hybrid precoding of a baseband and a radio frequency may be performed, which is suitable for application of a large-scale MIMO system, thereby achieving an effective tradeoff between system performance and complexity.

### CROSS REFERENCE TO RELATED APPLICATIONS

This application is a continuation application of International Application PCT/CN2014/089801 filed on Oct. 29, 2014, the entire contents of which are incorporated herein by reference.

### TECHNICAL FIELD

This disclosure relates to the field of communication technologies, and in particular to a method and apparatus for determining a codebook and a communication system.

### BACKGROUND

In the study of the future 5th generation mobile communication technologies, as one of candidate technologies, the mmWave technology is used jointly with the large-scale multiple-input multiple-output (MIMO) technology to provide a wider transmission bandwidth and a larger number of antennas, thereby improving the system performance. However, the increase of the number of antennas and the number of subcarriers will lead to that the baseband precoding technology is hard to be realized. On the one hand, the processing complexity is relatively high, the calculation of large-dimensional matrix multiplication needs to be performed on each subcarrier, and the complexity of the system increases along with increase of the number of antennas and bandwidth. And on the other hand, if it is intended to achieve flexible baseband precoding technology, each physical antenna needs to be configured with a set of radio frequency (RF) chains, including an amplifier, a mixer, a digital-to-analog converter, and an analog-to-digital converter, etc., which makes a high system cost.

If the baseband precoding technology is performed on a radio frequency unit, for each symbol, a large-dimensional matrix operation is performed, which may greatly lower the complexity of the system. And at the same time, radio frequency precoding operations may be achieved by relatively few RF chains; however, the system performance will also be correspondingly lowered; for example, the baseband precoding may select an optimal precoding codebook in each subcarrier.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that in a case of multiple pieces of user equipment, different pieces of user equipment may select different precoding codebooks, and the precoding codebooks adopted by the precoding operations at the radio frequency are identical in a whole symbol, that is, adaptive precoding of a carrier dimension and a user equipment dimension cannot be achieved, hence, the performance will be lowered.

Precoding (beamforming) in which a baseband and a radio frequency is mixed may perform precoding operations jointly in the baseband and the radio frequency as advantages of the baseband precoding and radio frequency precoding are combined, and is more suitable for large-scale MIMO and mmWave system applications, thereby achieving an effective tradeoff between a system performance (including flexibility) and complexity.

Embodiments of this disclosure provide a method and apparatus for determining a codebook and a communication system, which are suitable for large-scale MIMO system applications, by determining a codebook used for radio frequency precoding and a codebook used for baseband precoding, thereby achieving an effective tradeoff between a system performance and complexity.

According to a first aspect of the embodiments of this disclosure, there is provided a method for determining a codebook, applicable to a planar antenna array including multiple antenna elements, the multiple antenna elements forming multiple columns in a vertical direction and forming multiple rows in a horizontal direction, the method for determining a codebook including:

determining a first codebook used for radio frequency precoding on the basis of the number of the antenna elements in the planar antenna array and/or the number of radio frequency chains; wherein, the antenna elements in the same polarization direction in an antenna column in the vertical direction form one or more virtual antenna ports, the one or more virtual antenna ports being connected with multiple radio frequency chains; and

determining a second codebook used for baseband precoding on the basis of the number of the antenna elements in the planar antenna array and/or the number of the radio frequency chains.

According to a second aspect of the embodiments of this disclosure, there is provided an apparatus for determining a codebook, applicable to a planar antenna array including multiple antenna elements, the multiple antenna elements forming multiple columns in a vertical direction and forming multiple rows in a horizontal direction, the apparatus for determining a codebook including:

a first determining unit configured to determine a first codebook used for radio frequency precoding on the basis of the number of the antenna elements in the planar antenna array and/or the number of radio frequency chains; wherein, the antenna elements in the same polarization direction in an antenna column in the vertical direction form one or more virtual antenna ports, the one or more virtual antenna ports being connected with multiple radio frequency chains; and

a second determining unit configured to determine a second codebook used for baseband precoding on the basis of the number of the antenna elements in the planar antenna array and/or the number of the radio frequency chains.

According to a third aspect of the embodiments of this disclosure, there is provided a communication system, including:

a base station having a planar antenna array including multiple antenna elements, the multiple antenna elements forming multiple columns in a vertical direction and forming multiple rows in a horizontal direction; wherein, the antenna elements in the same polarization direction in an antenna column in the vertical direction form one or more virtual antenna ports, the one or more virtual antenna ports being connected with multiple radio frequency chains;

wherein, the base station determines a first codebook used for radio frequency precoding on the basis of the number of the antenna elements in the planar antenna array and/or the number of radio frequency chains, and determines a second codebook used for baseband precoding on the basis of the number of the antenna elements in the planar antenna array and/or the number of the radio frequency chains.

According to another aspect of the embodiments of the present disclosure, there is provided a computer readable program code, which, when executed in base station, will cause a computer unit to carry out the method for determining a codebook as described above in the base station.

According to a further aspect of the embodiments of the present disclosure, there is provided a computer readable medium, including a computer readable program code, which will cause a computer unit to carry out the method for determining a codebook as described above in a base station.

An advantage of the embodiments of this disclosure exists in that by determining a codebook used for radio frequency precoding and a codebook used for baseband precoding, hybrid precoding of a baseband and a radio frequency may be performed, which is suitable for application of a large-scale MIMO system, thereby achieving an effective tradeoff between a system performance and complexity.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. To facilitate illustrating and describing some parts of the disclosure, corresponding portions of the drawings may be exaggerated or reduced.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of a structure of a planar antenna array of the same polarization configuration;

FIG. 2 is a schematic diagram of a structure of a planar antenna array of cross polarization configuration;

FIG. 3 is a flowchart of the method for determining a codebook of an embodiment of this disclosure;

FIG. 4 is a flowchart of determining codewords of a first codebook and a second codebook by a base station of an embodiment of this disclosure;

FIG. 5 is a flowchart of determining codewords of a first codebook and a second codebook by user equipment of an embodiment of this disclosure;

FIG. 6 is a schematic diagram of connection between a radio frequency chain and physical antenna elements of an embodiment of this disclosure;

FIG. 7 is another schematic diagram of connection between a radio frequency chain and physical antenna elements of an embodiment of this disclosure;

FIG. 8 is a further schematic diagram of connection between radio frequency chains and physical antenna elements of an embodiment of this disclosure;

FIG. 9 is a schematic diagram of a structure of the apparatus for determining a codebook of an embodiment of this disclosure;

FIG. 10 is another schematic diagram of a structure of the apparatus for determining a codebook of the embodiment of this disclosure;

FIG. 11 is a schematic diagram of a structure of the base station of an embodiment of this disclosure; and

FIG. 12 is a schematic diagram of a structure of the communication system of an embodiment of this disclosure.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

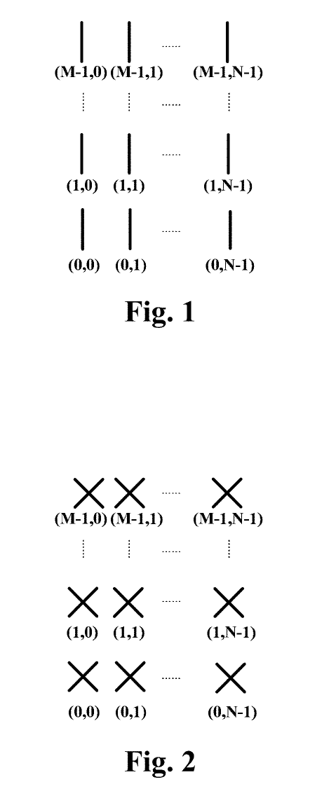

FIGS. 1 and 2 give schematic diagrams of structures of two planar antenna arrays. FIG. 1 is a schematic diagram of a structure of a planar antenna array of the same polarization configuration and FIG. 2 is a schematic diagram of a structure of a planar antenna array of cross polarization configuration.

As shown in FIG. 1, M antenna elements (also referred to as physical antenna elements) in the same polarization direction are arranged in each column in a vertical direction, and N columns are arranged in a horizontal direction. And as shown in FIG. 2, M antenna pairs of cross polarization are arranged in each column in the vertical direction, and total N columns of antenna pairs of cross polarization are arranged in the horizontal direction. That is, there are M physical antenna elements in each polarization direction in a vertical column, and there are N physical antenna elements in each polarization direction in a horizontal row.

In the above planar antenna array system, with increase of the number of antennas, overhead of reference signals increases. In order to bring a function of beam adjustment in the vertical direction and control the number of antenna ports at the same time, multiple physical antenna elements in the vertical direction may be virtualized into one or more antenna ports. Within a virtualized antenna port, beam direction in the vertical direction may be adjusted by weighting multiple physical antenna elements. Corresponding to weighting of the physical antenna elements, weighting for virtualized antenna ports is the precoding operation in a conventional sense.

The planar antenna array related to this disclosure is described above; however, this disclosure is not limited thereto. The embodiment of this disclosure shall be described below in detail.

### Embodiment 1

An embodiment of this disclosure provides a method for determining a codebook, applicable to a planar antenna array including multiple antenna elements, the multiple antenna elements forming multiple columns in a vertical direction and forming multiple rows in a horizontal direction. The method for determining a codebook may be applicable to a base station side, and may also be applicable to a user equipment side. Determination of a codebook may be performed in an off-line manner, and the generated codebook may be stored at the base station side and/or the user equipment side.

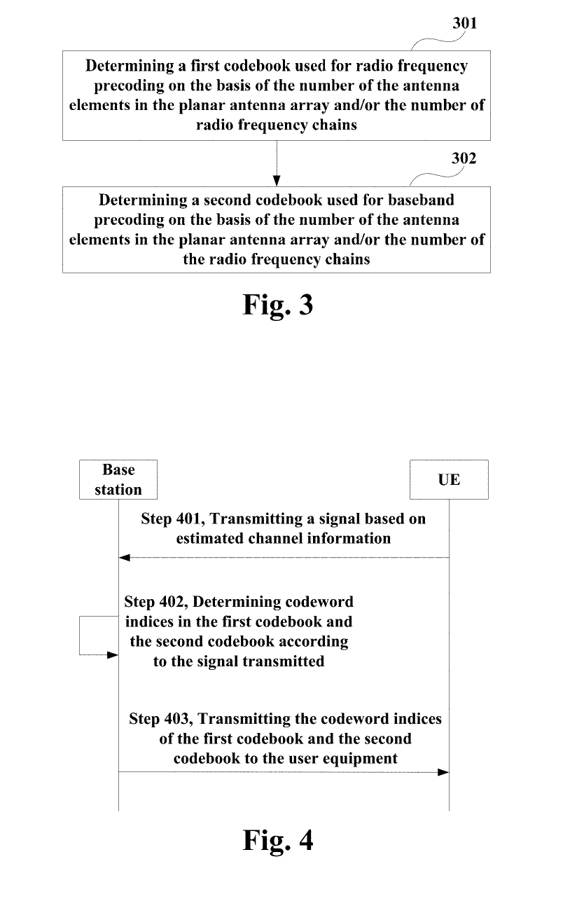

FIG. 3 is a flowchart of the method for determining a codebook of the embodiment of this disclosure. As shown in FIG. 3, the method for determining includes:

step 301: determining a first codebook used for radio frequency precoding on the basis of the number of the antenna elements in the planar antenna array and/or the number of radio frequency chains; the antenna elements in the same polarization direction in an antenna column in the vertical direction form one or more virtual antenna ports, the one or more virtual antenna ports being connected with multiple radio frequency chains; and

step 302: determining a second codebook used for baseband precoding on the basis of the number of the antenna elements in the planar antenna array and/or the number of the radio frequency chains.

In this embodiment, for example, the first codebook used for radio frequency precoding may be pre-generated, according to the number N of the antenna elements in each polarization direction of a row in the horizontal direction in the planar antenna array, the number M of the antenna elements in each polarization direction of a column in the vertical direction in the planar antenna array, and/or the number Q of the radio frequency chains. For example, the second codebook used for baseband precoding may be pre-generated according to the number N of the antenna elements in each polarization direction of a row in the horizontal direction in the planar antenna array and/or the number Q of the radio frequency chains. Furthermore, in determining the second codebook, following factors may be taken into account: the number Ns of data streams supported by the baseband, and/or a precoding codebook of an actual antenna port.

In this embodiment, each of the virtual antenna ports may correspond to multiple beams, and a product of the number of the virtual antenna ports and the number of the beams to which each of the virtual antenna ports corresponds is definite. That is, the same codebook (the first codebook and/or the second codebook) may contain cases of multiple values of Q and/or cases of multiple values of l, and following embodiments 2 and 3 may be referred to for particular meanings of Q and l.

In this embodiment, the first codebook and the second codebook may be pre-generated at the base station side, and then transmitted to the user equipment side; may also be pre-generated respectively at the base station side and the user equipment side (for example, the base station configures information for the user equipment, informing the number of configured antenna ports, etc., and the user equipment generates the first codebook and the second codebook by itself); and may also be pre-generated by a third party, and then transmitted to the base station and the user equipment. Which device generates the first codebook and the second codebook is not limited in this embodiment. Hence, the base station side and the user equipment side may prestore the first codebook and the second codebook.

In this embodiment, the codebook of an actual antenna port (which may be referred to as a third codebook) may be a conventional LTE codebook used for performing port precoding. The precoding of the radio frequency and the baseband may be jointly performed with the first codebook, the second codebook and the third codebook.

In this embodiment, when communication is performed between the base station and the user equipment, the base station may determine one or more particular codewords, or the user equipment may determine one or more particular codewords and feed back to the base station.

FIG. 4 is a flowchart of determining codewords of the first codebook and the second codebook by the base station of the embodiment of this disclosure. As shown in FIG. 4, the determining the codewords includes:

step 401: transmitting a signal by user equipment to a base station on the basis of estimated channel information;

for example, the user equipment may transmit a reference signal (such as a sounding reference signal (SRS)), or data information, etc., to the base station; however, this disclosure is not limited thereto;

step 402: determining codeword indices in the first codebook and the second codebook according to the signal transmitted by the user equipment;

for example, the base station side may jointly determine the codeword indices to be used in the first codebook and the second codebook, according to a measured arrival angular direction of the signal of the user equipment side and a case of a simultaneously scheduled arrival angle of the user equipment; and related technologies may be referred to for how to determine the codeword indices;

for the first codebook, one or more beams may be transmitted at each virtual antenna port; and for the second codebook, transmission beams may be selected from multiple beams supported by one or more virtual antenna ports;

step 403: transmitting the codeword indices of the first codebook and the second codebook to the user equipment.

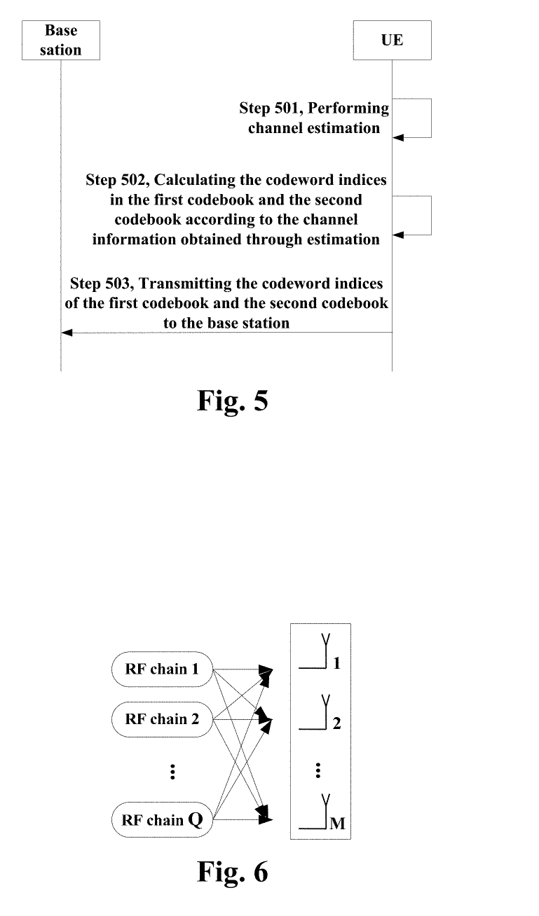

FIG. 5 is a flowchart of determining codewords of the first codebook and a second codebook by the user equipment of this disclosure. As shown in FIG. 5, the determining the codewords includes:

step 501: performing channel estimation by the user equipment;

step 502: calculating the codeword indices in the first codebook and the second codebook according to the channel information obtained through estimation;

the user equipment may calculate the codeword indices according to a certain calculation rule, and related technologies may be referred to for how to determine the codeword indices;

step 503: transmitting the codeword indices of the first codebook and the second codebook by the user equipment to the base station.

In this embodiment, the first codebook and the second codebook may be predetermined, and prestored in the base station and the user equipment. In performing communication, particular codeword indices may be determined by the base station or the user equipment, and then a precoding matrix used for the radio frequency and a precoding matrix used for the baseband are determined, finally a precoding matrix of the actual antenna port is determined.

It should be noted that FIGS. 4 and 5 only illustratively show how to determine particular codewords; however, this disclosure is not limited thereto, and related technologies may be referred to for how to determine the codewords.

Hence, by determining a codebook used for radio frequency precoding and a codebook used for baseband precoding, hybrid precoding of a baseband and a radio frequency may be performed, which is suitable for application of a large-scale MIMO system, thereby achieving an effective tradeoff between a system performance and complexity.

### Embodiment 2

On the basis of Embodiment 1, the embodiment of this disclosure describes a case where physical antenna elements of the same polarization direction in a column of antennas in the vertical direction are virtualized into a virtual antenna port. The virtual antenna port is connected to Q radio frequency chains. That is, it is assumed that all physical antenna elements of the same polarization direction in a column of antennas in the vertical direction are virtualized into a virtual antenna port, and each virtual antenna port is connected to Q RF chains.

In this embodiment, each RF chain may be connected to all physical antenna elements of a certain virtual antenna port. FIG. 6 is a schematic diagram of connection between a radio frequency chain and physical antenna elements of the embodiment of this disclosure. As shown in FIG. 6, a certain RF chain may be connected to all M physical antenna elements.

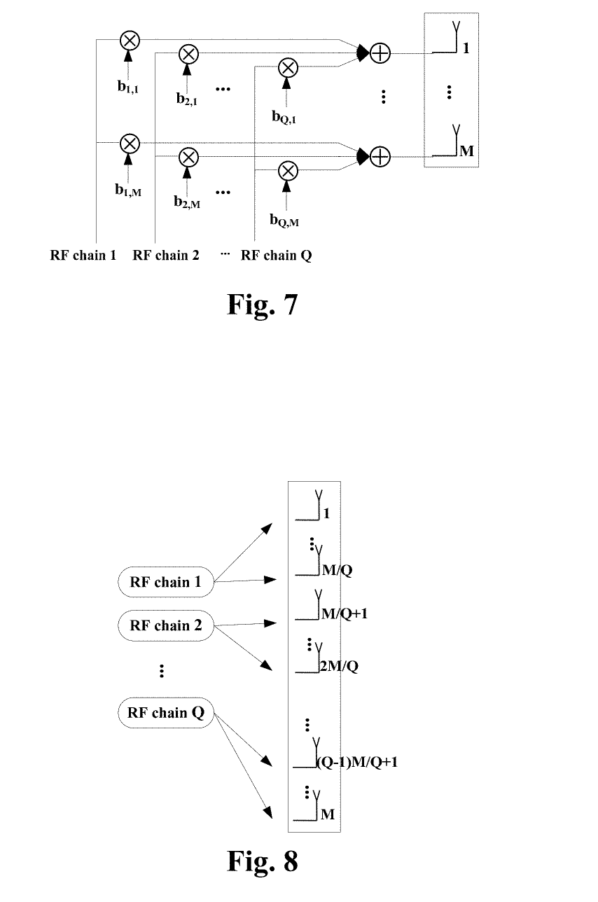

FIG. 7 is another schematic diagram of connection between an RF chain and physical antenna elements of the embodiment of this disclosure, in which particular connection relationship between a radio frequency chain and physical antenna elements is shown. Where, b_{i,j}(i=1, 2, . . . , Q; j=1, 2, . . . , M) denotes weighting coefficients of radio frequency precoding.

When the planar antenna array is of antenna configuration of same polarization, the first codebook may be determined by using formula (1) below:

$${W}_{RF} = ( \begin{matrix}X & … & 0 \\ ⋮ & ⋱ & ⋮ \\ 0 & … & X\end{matrix} ) ∈ {C}^{NM \times NQ} , \\ X = [ \begin{matrix}{b}_{1} & … & {b}_{Q}\end{matrix} ] ∈ {C}^{M \times Q} \\ {b}_{q} = {[ {b}_{q , 1} , {b}_{q , 2} , … , {b}_{q , M} ]}^{T} ( q = 1 , 2 , … , Q ) ; \qquad ( 1 )$$

where, W_{RF} denotes the first codebook, C denotes a complex set, N is the number of the physical antenna elements of a row in each polarization direction in the planar antenna array in the horizontal direction, M is the number of the physical antenna elements of a column in each polarization direction in the planar antenna array in the vertical direction, and b_{q} is a discrete Fourier transform (DFT) vector, q=1, 2, . . . Q.

That is, b_{q}(q=1, 2, . . . , Q) is a DFT vector, with its dimension being M×1. Namely, in an RF unit, each virtual antenna port may support Q beams at the same time as it is connected to Q RF chains; where, b₁, b₂, . . . , b_{Q} may be orthogonal to each other, or, b₁, b₂, . . . , b_{Q} correspond to neighboring beams.

In this embodiment, multiple factors may be taken into account in selecting X. For example, b₁, b₂, . . . , b_{Q} are orthogonal to each other. Hence, codewords of one W_{RF} may be used to cover beams within a relatively large range, and at the same time, multi-user MIMO may be supported. For another example, b₁, b₂, . . . , b_{Q} are neighboring beams, and may support a slow change of a frequency-domain beam direction.

In this embodiment, when the planar antenna array is of antenna configuration of same polarization, the second codebook may be determined by using formula (2) below:

W_{BB}=AB,AεC^{NQ×N},BεC^{N×N}^{_{S}},

A=(E_{q,1} . . . E_{q,N})^{T},E_{q,n}εR^{Q×N} (2)

where, W_{BB} denotes the second codebook, R denotes a real number set, a matrix B denotes a precoding matrix of an actual antenna port, Ns is the number of data streams supported by the baseband, and E_{q,n} denotes a matrix with only elements at a q-th row and an n-th column being 1 and other elements being 0, n=1, 2, . . . N.

Furthermore, matrix A may be expressed in another way, that is,

$$A = ( \begin{matrix}{e}_{q} & 0 & … & 0 \\ 0 & {e}_{q} & ⋮ & 0 \\ ⋮ & ⋮ & ⋱ & ⋮ \\ 0 & 0 & … & {e}_{q}\end{matrix} ) ∈ {C}^{NQ \times N}$$

where, e_{q} is a unit vector of Q×1, a q-th element is 1, and all other elements are 0.

In this embodiment, matrix A is used for selection of radio frequency beams, that is, a beam is selected from Q beams supported by a virtual antenna port and then is transmitted. E_{q,n} denotes a matrix with only elements at a q-th row and an n-th column being 1 and other elements being 0. Matrix B is a precoding matrix of the actual antenna port, which may reuse 2-antenna, 4-antenna and 8-antenna precoding codebooks of an LTE system, etc., and may represent a single codebook, or a dual codebook. And Ns is the number of data streams supported by the baseband.

Furthermore, a scheme of antenna configuration of cross polarization is similar to the scheme of the antenna configuration of same polarization, with only exception that after all physical antenna elements of the same polarization direction in a column of antennas in the vertical direction are virtualized into a virtual antenna port, a total number of virtual antenna ports is 2N, dimensions of W_{RF} and W_{BB} and their sub-matrices change.

In particular, in a case where the planar antenna array is of antenna configuration of cross polarization, the first codebook is determined by using formula (3) below:

$${W}_{RF} = ( \begin{matrix}X & … & 0 \\ ⋮ & ⋱ & ⋮ \\ 0 & … & X\end{matrix} ) ∈ {C}^{2 NM \times 2 NQ} , \\ X = [ \begin{matrix}{b}_{1} & … & {b}_{Q}\end{matrix} ] ∈ {C}^{M \times Q} ; \qquad ( 3 )$$

where, W_{RF} denotes the first codebook, C denotes a complex set, N is the number of the physical antenna elements of a row in each polarization direction in the planar antenna array in the horizontal direction, M is the number of the physical antenna elements of a column in each polarization direction in the planar antenna array in the vertical direction, and b_{q} is a discrete Fourier transform vector, q=1, 2, . . . Q.

And in a case where the planar antenna array is of antenna configuration of cross polarization, the second codebook is determined by using formula (4) below:

W_{BB}=AB,AεC^{2NQ×N},BεC^{2N×N}^{_{S}},

A=(E_{q,1} . . . E_{q,N})^{T},E_{q,n}εR^{Q×2N} (4);

where, W_{BB} denotes the second codebook, R denotes a real number set, a matrix B denotes a precoding matrix of an actual antenna port, Ns is the number of data streams supported by the baseband, and E_{q,n} denotes a matrix with only elements at a q-th row and an n-th column being 1 and other elements being 0, n=1, 2, . . . 2N.

In this embodiment, the first codebook of the radio frequency precoding and the second codebook of the baseband precoding may only contain codewords when a specific value is taken for the number of RF chains, such as Q=2, or Q=4, etc., and may simultaneously contain codewords when different values or all possible values are taken for the number of RF chains; and at this moment, Q=1, 2, 3, . . . , and a maximum value of Q is the number of RF chains actually configured by the system for a column of antenna elements of the same polarization direction in the vertical direction.

It should be appreciated that above formulae (1)-(4) only illustratively show the determination of the first codebook and the second codebook; however, this disclosure is not limited thereto.

It can be seen from the above embodiment that by determining a codebook used for radio frequency precoding and a codebook used for baseband precoding, hybrid precoding of a baseband and a radio frequency may be performed, which is suitable for application of a large-scale MIMO system, thereby achieving an effective tradeoff between a system performance and complexity.

### Embodiment 3

On the basis of Embodiment 1, the embodiment of this disclosure describes a case where physical antenna elements of the same polarization direction in a column of antennas in the vertical direction are virtualized into multiple virtual antenna ports. The multiple virtual antenna ports are connected to Q radio frequency chains.

In virtualization of antenna ports, if all physical antenna elements of the same polarization direction in a column of antennas in the vertical direction are virtualized into Q antenna ports, Q RF chains are also needed. For the sake of explanation, it is assumed that the number of the virtualized antenna ports is T (T=1, 2, . . . Q), and T is divisible by Q. The Q RF chains may be evenly allocated to T virtual antenna ports; however, this disclosure is not limited there to.

FIG. 8 is a schematic diagram of connection between the RF chains and physical antenna elements of the embodiment of this disclosure, in which a case where M is divisible by Q is shown. As shown in FIG. 8, an RF chain may be connected to multiple physical antenna elements, and each RF chain may be connected to only some physical antenna elements.

In this embodiment, the physical antenna elements in the same polarization direction in an antenna column in the vertical direction form T=Q/l (l=1, 2, . . . Q) virtual antenna ports, the T virtual antenna ports being connected with Q radio frequency chains;

in a case where the planar antenna array is of antenna configuration of same polarization, the first codebook is determined by using formula (5) below:

$${W}_{RF} = ( \begin{matrix}X & … & 0 \\ ⋮ & ⋱ & ⋮ \\ 0 & … & X\end{matrix} ) ∈ {C}^{NM \times NQ} , \\ X = ( \begin{matrix}P & … & 0 \\ ⋮ & ⋱ & ⋮ \\ 0 & … & P\end{matrix} ) ∈ {C}^{M \times Q} , \\ X = [ \begin{matrix}{p}_{1} & … & {p}_{l}\end{matrix} ] ∈ {C}^{\frac{M}{T} \times l} ; \qquad ( 5 )$$

where, W_{RF} denotes the first codebook, C denotes a complex set, N is the number of the physical antenna elements of a row in each polarization direction in the planar antenna array in the horizontal direction, M is the number of the physical antenna elements of a column in each polarization direction in the planar antenna array in the vertical direction;

at this moment, each virtual antenna port corresponds to MIT physical antenna elements and is connected to l radio frequency chains, 1=Q/T, ρᵢ(i=1, 2, . . . , l) is a DFT vector of a dimension of

$$\frac{M}{T} \times 1.$$

When l=1, that is, T=Q,

$$X = ( \begin{matrix}p & … & 0 \\ ⋮ & ⋱ & ⋮ \\ 0 & … & p\end{matrix} ) ∈ {C}^{M \times Q} ;$$

p is the DFT vector of a dimension of

$$\frac{M}{T} \times 1 ,$$

N_{T} is a size of the codebook of the DFT vector; and at this moment, each virtual antenna port is connected to only one RF chain, and supports one RF beam.

When l=Q, that is, T=1, X=[b₁ . . . b_{Q}]εC^{M×Q} is the scheme in Embodiment 2. For W_{BB},

$${W}_{BB} = AB , A ∈ {C}^{NQ \times NT} , B ∈ {C}^{NT \times {N}_{S}} \\ A = ( \begin{matrix}{e}_{q} & 0 & … & 0 \\ 0 & {e}_{q} & ⋮ & 0 \\ ⋮ & ⋮ & ⋱ & ⋮ \\ 0 & 0 & … & {e}_{q}\end{matrix} ) ∈ {C}^{NQ \times NT} \qquad ( 6 )$$

where, e_{q} is a unit vector of

$$\frac{Q}{T} \times 1 ,$$

a q-th element being 1 and all other elements being 0.

In a case where the planar antenna array is of antenna configuration of cross polarization, the first codebook is determined by using formula (7) below:

$${W}_{RF} = ( \begin{matrix}X & … & 0 \\ ⋮ & ⋱ & ⋮ \\ 0 & … & X\end{matrix} ) ∈ {C}^{2 NM \times 2 NQ} , \\ X = ( \begin{matrix}P & … & 0 \\ ⋮ & ⋱ & ⋮ \\ 0 & … & P\end{matrix} ) ∈ {C}^{M \times Q} , \\ P = [ \begin{matrix}{p}_{1} & … & {p}_{l}\end{matrix} ] ∈ {C}^{\frac{M}{T} \times l} ; \qquad ( 7 )$$

where, l=1, 2, Q, W_{RF} denotes the first codebook, C denotes a complex set, N is the number of the physical antenna elements of a row in each polarization direction in the planar antenna array in the horizontal direction, M is the number of the physical antenna elements of a column in each polarization direction in the planar antenna array in the vertical direction;

when T=Q/l, each virtual antenna port corresponds to MIT physical antenna elements and is connected to l RF chains, and pᵢ is a DFT vector, i=1, 2, . . . l.

For W_{BB},

$${W}_{BB} = AB , A ∈ {C}^{2 NQ \times 2 NT} , B ∈ {C}^{2 NT \times {N}_{S}} \\ A = ( \begin{matrix}{e}_{q} & 0 & … & 0 \\ 0 & {e}_{q} & ⋮ & 0 \\ ⋮ & ⋮ & ⋱ & ⋮ \\ 0 & 0 & … & {e}_{q}\end{matrix} ) ∈ {C}^{2 NQ \times 2 NT} ; \qquad ( 8 )$$

where, e_{q} is a unit vector of

$$\frac{Q}{T} \times 1 ,$$

a q-tn element being 1 and all other elements being 0.

It should be appreciated that sizes of the DFT vectors mentioned in the above description may all be suitably designed according to situations of channels; however, this disclosure is not limited thereto.

It can be seen from the above embodiment that the first codebook of the radio frequency precoding and the second codebook of the baseband precoding may only contain codewords when a specific value is taken for l, that is, codewords when the number of the virtualized antenna ports of the same polarization direction in the vertical direction is fixed, and may simultaneously contain codewords when different values or all values are taken for l.

It can be seen from the above embodiment that the first codebook of the radio frequency precoding and the second codebook of the baseband precoding may only contain codewords when a specific value is taken for the number of RF chains, such as Q=2, or Q=4, etc., and may simultaneously contain codewords when different values or all possible values are taken for the number of RF chains; and at this moment, Q=1, 2, 3, . . . , and a maximum value of Q is the number of RF chains actually configured by the system for a column of antennal elements of the same polarization direction in the vertical direction.

It should be appreciated that above formulae (5)-(8) only illustratively show the determination of the first codebook and the second codebook; however, this disclosure is not limited thereto.

It can be seen from the above embodiment that by determining a codebook used for radio frequency precoding and a codebook used for baseband precoding, hybrid precoding of a baseband and a radio frequency may be performed, which is suitable for application of a large-scale MIMO system, thereby achieving an effective tradeoff between a system performance and complexity.

### Embodiment 4

On the basis of embodiments 1-3, the embodiment of this disclosure further describes the case of multiple pieces of user equipment. In this embodiment, in the case of multiple pieces of user equipment, different virtual antenna ports may be used to support different pieces of user equipment.

In this embodiment, the virtual antenna ports may be grouped, and multiple pieces of user equipment are supported by using the grouped virtual antenna ports. Following description is given with an example.

For example, for the planar antenna array of the same polarization shown in FIG. 1, it is assumed that there are totally 160 physical antenna elements, which are divided into 10 rows and 16 columns, the 10 physical antenna elements in each column being virtualized into one virtual antenna port, each virtual antenna port being connected to Q RF chains, and the 16 virtual antenna ports being divided into U groups to support the user equipment; where, U is the number of the groups.

Table 1 gives the numbers of pieces of user equipment that can be supported and the numbers of down tilt angles that can be supported in different antenna grouping methods.

TABLE 1

| | | | Number of pieces | |
|---|---|---|---|---|
| | | | of user equipment | Number of |
| | Number of antenna | | that can | down tilt angles |
| U | ports in each group | Q | be supported | that can be supported |
| 1 | 16 | 1 | 16 | 1 |
| 2 | 8 | 1 | 16 | 2 |
| 4 | 4 | 1 | 16 | 4 |
| 8 | 2 | 1 | 16 | 8 |
| 16 | 1 | 1 | 10 | 10 |
| 1 | 16 | 2 | 32 | 2 |
| 2 | 8 | 2 | 32 | 4 |

It can be seen from the above table 1 that different antenna grouping methods and the number of connected RF chains may affect supporting multi-user MIMO (MU-MIMO). For example, when the 16 antenna ports are divided into 8 groups, each group has only two virtual antenna ports, and two pieces of user equipment are supported, down tilt angles of the two pieces of user equipment being identical, but their horizontal angles being different. The eight groups of antennas support total 16 pieces of user equipment, and down tilt angles of the user equipment supported by each group of antennas may be different. And when the 16 antenna ports are divided into two groups, down tilt angles of the eight pieces of user equipment supported by each group are identical, and their horizontal angles are different, and the two groups may totally support two types of down tilt angles.

In this embodiment, the virtual antenna ports may be grouped according to down tilt angle distribution of the multiple pieces of user equipment. For example, in the case of multiple pieces of user equipment, if the user equipment that is jointly scheduled have multiple types of down tilt angle distribution, a scheme with relatively large value of U may be taken into account for use; and when the down tilt angles of the user equipment are relatively concentrated, a scheme with relatively small value of U may be selected.

Or, the virtual antenna ports may be grouped according to the number of down tilt angles of the multiple pieces of user equipment. And a value of U may be determined directly according to the number of down tilt angles of the user equipment.

It can be seen from the above embodiment that by determining a codebook used for radio frequency precoding and a codebook used for baseband precoding, hybrid precoding of a baseband and a radio frequency may be performed, which is suitable for application of a large-scale MIMO system, and effective tradeoff between a system performance and complexity may be achieved. And furthermore, by grouping the virtual antenna ports, different virtual antenna ports may be used to support different pieces of user equipment.

### Embodiment 5

An embodiment of this disclosure provides a method for determining the number of virtual antenna ports, applicable to a user equipment side. This embodiment may either be jointly used with Embodiment 2 or Embodiment 3, or may be used individually.

In this embodiment, it is assumed that there are M antenna elements of the same polarization direction in the vertical direction, which may be virtualized into one or more logic antenna ports, and there are N antenna elements of the same polarization direction in the horizontal direction. And furthermore, it is assumed that K antenna elements of the same polarization direction in the vertical direction may be virtualized into one logic antenna port.

First, an initial value of K may be set to be relatively small K₀, which may be 2, 4, 5, 8, and 10, etc., and may be divisible by M. And furthermore, a value of M/K₀ is not in excess of the number of RF chains to which the antenna elements of the same polarization direction in the vertical direction are connected, that is, the number of RF chains to which the antenna elements of the same polarization direction in the vertical direction are connected decides a maximum number of antenna ports that may be virtualized by it. The base station transmits a reference signal according to a value of K₀. For example, in antenna configuration of the same polarization, if the number of antenna ports in the vertical direction is M/K₀, the base station transmits an M/K₀-ports reference signal (such as a channel state information reference signal (CSI-RS)).

It is assumed that channels between the M/K₀ ports estimated at the user equipment side and all antennas of a receiving device are Ĥ_{V}, and their dimensions are

$${N}_{R} \times \frac{M}{{K}_{0}} ;$$

where, N_{R} is the number of antennas at the user equipment side. With the channel information obtained through estimation, the user equipment side may convert the M/K₀ ports into virtualized M/iK₀ (i=1, 2, . . . , M/K₀) antenna ports virtualized in each polarization direction in the vertical direction, each antenna port containing channel information on iK₀ antenna elements. Such a process is as shown below:

$${\hat{H}}_{V} {\hat{H}}_{V} {W}_{P}$$

$${W}_{P} = diag \{ \overbrace{{w}_{p}^{i} , {w}_{p}^{i} , … , {w}_{p}^{i}}^{M / {iK}_{0}} \} ∈ {C}^{\frac{M}{{K}_{0}} \times \frac{M}{{iK}_{0}}}$$

$${w}_{p}^{i} = {[ \begin{matrix}1 & {w}_{{K}_{0} + 1} & … & {w}_{( i - 1 ) {K}_{0} + 1}\end{matrix} ]}^{T} ∈ {C}^{i \times 1}$$

$${w}_{k} = \frac{1}{\sqrt{{K}_{0}}} exp [ - j \frac{2 π}{λ} ( k - 1 ) {d}_{V} cos {θ}_{etilt} ] ;$$

where, d_{V} is a distance between neighboring antenna elements in the vertical direction, and θₑₜᵢₗₜ is a down tilt angle used in a weighting design; when a DFT vector is used in vertical weighting, θₑₜᵢₗₜ may be written as n/N_{K}_{₀}; where, N_{K}_{₀} is a size of the DFT vector, and n is a particularly used codeword index.

With such processing, the user equipment may obtain the channel information when a column of antenna elements of the same polarization direction in the vertical direction are virtualized into different numbers of antenna ports, and calculate the precoding matrices of the antenna ports and estimate the performance of the system in cases of different numbers of ports, thereby determining an optimal number of antenna ports and corresponding precoding matrix indices (PMIs), channel quality indication (CQI), and rank indication (RI), of the antenna ports.

Hence, the user equipment may determine the number of the antenna ports virtualized by a column of antenna elements of the same polarization direction in the vertical direction and feed back the number to the base station side.

### Embodiment 6

An embodiment of this disclosure provides an apparatus for determining a codebook, applicable to a planar antenna array including multiple antenna elements, the multiple antenna elements forming multiple columns in a vertical direction and forming multiple rows in a horizontal direction. This embodiment corresponds to the methods for determining a codebook described in embodiments 1-4, with identical contents being not going to be described herein any further.

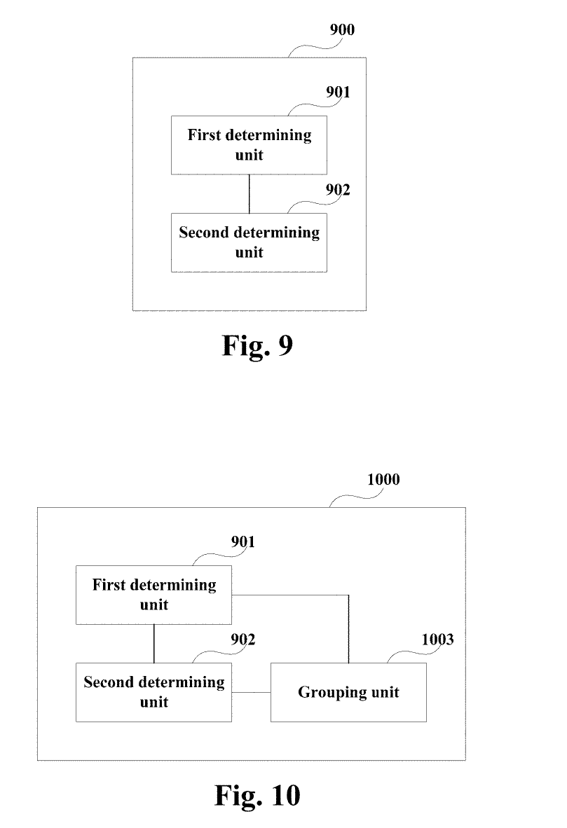

FIG. 9 is a schematic diagram of a structure of the apparatus for determining a codebook of the embodiment of this disclosure. As shown in FIG. 9, the apparatus 900 for determining a codebook includes a first determining unit 901 and a second determining unit 902.

The first determining unit 901 is configured to determine a first codebook used for radio frequency precoding on the basis of the number of the antenna elements in the planar antenna array and/or the number of radio frequency chains; wherein, the antenna elements in the same polarization direction in an antenna column in the vertical direction form one or more virtual antenna ports, the one or more virtual antenna ports being connected with multiple radio frequency chains;

and the second determining unit 902 is configured to determine a second codebook used for baseband precoding on the basis of the number of the antenna elements in the planar antenna array and/or the number of the radio frequency chains.

In an implementation, the antenna elements in the same polarization direction in an antenna column in the vertical direction form a virtual antenna port, the virtual antenna port being connected with Q radio frequency chains;

in a case where the planar antenna array is of antenna configuration of same polarization, the first determining unit 901 is configured to determine the first codebook by using formula (1) below:

$${W}_{RF} = ( \begin{matrix}X & … & 0 \\ ⋮ & ⋱ & ⋮ \\ 0 & … & X\end{matrix} ) ∈ {C}^{NM \times NQ} , \\ X = [ \begin{matrix}{b}_{1} & … & {b}_{Q}\end{matrix} ] ∈ {C}^{M \times Q} ; \qquad ( 1 )$$

where, W_{RF} denotes the first codebook, C denotes a complex set, N is the number of the antenna elements of a row in each polarization direction in the planar antenna array in the horizontal direction, M is the number of the antenna elements of a column in each polarization direction in the planar antenna array in the vertical direction, and b_{q} is a discrete Fourier transform vector, q=1, 2, . . . Q;

in a case where the planar antenna array is of antenna configuration of same polarization, the second determining unit 902 is configured to determine the second codebook by using formula (2) below:

W_{BB}=AB,AεC^{NQ×N},BεC^{N×N}^{_{S}},

A=(E_{q,1} . . . E_{q,N})^{T},E_{q,n}ΣR^{Q×N} (2);

where, W_{BB} denotes the second codebook, R denotes a real number set, a matrix B denotes a precoding matrix of an actual antenna port, Ns is the number of data streams supported by the baseband, and E_{q,n} denotes a matrix with only elements at a q-th row and an n-th column being 1 and other elements being 0, n=1, 2, . . . N.

In a case where the planar antenna array is of antenna configuration of cross polarization, the first determining unit 901 is configured to determine the first codebook by using formula (3) below:

$${W}_{RF} = ( \begin{matrix}X & … & 0 \\ ⋮ & ⋱ & ⋮ \\ 0 & … & X\end{matrix} ) ∈ {C}^{2 NM \times 2 NQ} , \\ X = [ \begin{matrix}{b}_{1} & … & {b}_{Q}\end{matrix} ] ∈ {C}^{M \times Q} ; \qquad ( 3 )$$

where, W_{RF} denotes the first codebook, C denotes a complex set, N is the number of the antenna elements of a row in each polarization direction in the planar antenna array in the horizontal direction, M is the number of the antenna elements of a column in each polarization direction in the planar antenna array in the vertical direction, and b_{q} is a discrete Fourier transform vector, q=1, 2, . . . Q;

In a case where the planar antenna array is of antenna configuration of cross polarization, the second determining unit 902 is configured to determine the second codebook by using formula (4) below:

W_{BB}=AB,AεC^{2NQ×N},BεC^{2N×N}^{_{S}},

A=(E_{q,1} . . . E_{q,N})^{T},E_{q,n}εR^{Q×2N}=(E_{q,n} (4);

where, W_{BB} denotes the second codebook, R denotes a real number set, a matrix B denotes a precoding matrix of an actual antenna port, Ns is the number of data streams supported by the baseband, and E_{q,n} denotes a matrix with only elements at a q-th row and an n-th column being 1 and other elements being 0, n=1, 2, . . . 2N.

In another implementation, the antenna elements in the same polarization direction in an antenna column in the vertical direction form T virtual antenna ports, the T virtual antenna ports being connected with Q radio frequency chains;

in a case where the planar antenna array is of antenna configuration of same polarization, the first determining unit 901 is configured to determine the first codebook by using formula (5) below:

$${W}_{RF} = ( \begin{matrix}X & … & 0 \\ ⋮ & ⋱ & ⋮ \\ 0 & … & X\end{matrix} ) ∈ {C}^{NM \times NQ} , \\ X = ( \begin{matrix}P & … & 0 \\ ⋮ & ⋱ & ⋮ \\ 0 & … & P\end{matrix} ) ∈ {C}^{M \times Q} , \\ P = [ {p}_{1} \begin{matrix}… & {p}_{l}\end{matrix} ] ∈ {C}^{\frac{M}{T} \times l} ; \qquad ( 5 )$$

where, W_{RF} denotes the first codebook, C denotes a complex set, N is the number of the antenna elements of a row in each polarization direction in the planar antenna array in the horizontal direction, M is the number of the antenna elements of a column in each polarization direction in the planar antenna array in the vertical direction;

when T=Q/l, each virtual antenna port corresponds to M/T antenna elements and is connected with l radio frequency chains, 1=1, 2, . . . Q, and pᵢ is a discrete Fourier transform vector, i=1, 2, . . . l.

In a case where the planar antenna array is of antenna configuration of same polarization, the second determining unit 902 is configured to determine the second codebook by using formula (6) below:

$${W}_{BB} = AB , A \times {C}^{NQ \times NT} , B ∈ {C}^{NT \times {N}_{S}} , \\ A = ( \begin{matrix}{e}_{q} & 0 & … & 0 \\ 0 & {e}_{q} & ⋮ & 0 \\ ⋮ & ⋮ & ⋱ & ⋮ \\ 0 & 0 & … & {e}_{q}\end{matrix} ) ∈ {C}^{NQ \times NT} ; \qquad ( 6 )$$

where, W_{BB} denotes the second codebook, a matrix B denotes a precoding matrix of an actual antenna port, Ns is the number of data streams supported by the baseband, and e_{q} is a unit vector of

$${W}_{RF} = ( \begin{matrix}X & … & 0 \\ ⋮ & ⋱ & ⋮ \\ 0 & … & X\end{matrix} ) ∈ {C}^{2 NM \times 2 NQ} , \\ X = ( \begin{matrix}P & … & 0 \\ ⋮ & ⋱ & ⋮ \\ 0 & … & P\end{matrix} ) ∈ {C}^{M \times Q} , \\ P = [ {p}_{1} \begin{matrix}… & {p}_{l}\end{matrix} ] ∈ {C}^{\frac{M}{T} \times l} ; \qquad ( 7 )$$

a q-th element being 1 and all other elements being 0.

In a case where the planar antenna array is of antenna configuration of cross polarization, the first determining unit 901 is configured to determine the first codebook by using formula (7) below:

$$\frac{Q}{T} \times 1 ,$$

where, W_{RF} denotes the first codebook, C denotes a complex set, N is the number of the antenna elements of a row in each polarization direction in the planar antenna array in the horizontal direction, M is the number of the antenna elements of a column in each polarization direction in the planar antenna array in the vertical direction;

when T=Q/l, each virtual antenna port corresponds to M/T antenna elements and is connected with l radio frequency chains, 1=1, 2, . . . Q, and pᵢ is a discrete Fourier transform vector, i=1, 2, . . . l.

In a case where the planar antenna array is of antenna configuration of cross polarization, the second determining unit 902 is configured to determine the second codebook by using formula (8) below:

$${W}_{BB} = AB , A \times {C}^{NQ \times NT} , B ∈ {C}^{NT \times {N}_{S}} , \\ A = ( \begin{matrix}{e}_{q} & 0 & … & 0 \\ 0 & {e}_{q} & ⋮ & 0 \\ ⋮ & ⋮ & ⋱ & ⋮ \\ 0 & 0 & … & {e}_{q}\end{matrix} ) ∈ {C}^{2 NQ \times 2 NT} ; \qquad ( 8 )$$

where, W_{BB} denotes the second codebook, a matrix B denotes a precoding matrix of an actual antenna port, Ns is the number of data streams supported by the baseband, and e_{q} is a unit vector of

$$\frac{Q}{T} \times 1 ,$$

a q-th element being 1 and all other elements being 0.

In this embodiment, the apparatus 900 for determining a codebook may be configured in a base station, may be configured in user equipment, and may also be configured in a third-party device in a communication system. With the apparatus 900 for determining a codebook, the base station and the user equipment may be made to prestore the first codebook and the second codebook. Further description is given below taking that the apparatus 900 for determining a codebook is configured in the base station as an example.

FIG. 10 is another schematic diagram of a structure of the apparatus for determining a codebook of the embodiment of this disclosure. As shown in FIG. 10, the apparatus 1000 for determining a codebook includes a first determining unit 901 and a second determining unit 902, as described above.

As shown in FIG. 10, the apparatus 1000 for determining a codebook may further include a grouping unit 1003 configured to group the virtual antenna ports, and support multiple pieces of user equipment by using the grouped virtual antenna ports.

The grouping unit 1003 may be configured to group the virtual antenna ports according to down tilt angle distribution of the multiple pieces of user equipment, or group the virtual antenna ports according to the number of down tilt angles of the multiple pieces of user equipment.

This embodiment further provides a base station, configured with the above apparatus 900 or 1000 for determining a codebook.

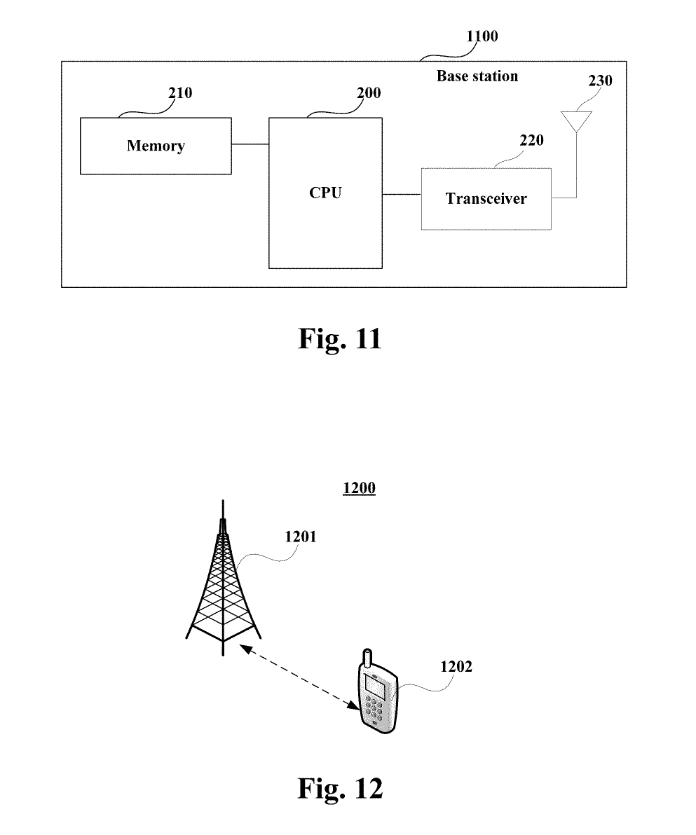

FIG. 11 is a schematic diagram of a structure of the base station of the embodiment of this disclosure. As shown in FIG. 11, the base station 1100 may include a central processing unit (CPU) 200 and a memory 210, the memory 210 being coupled to the central processing unit 200. The memory 210 may store various data, and furthermore, it may store a program for information processing, and execute the program under control of the central processing unit 200, so as to receive various information transmitted by the user equipment, and to transmit various information to the user equipment.

In this embodiment, the central processing unit 200 may be configured to perform following control: carrying out the methods for determining a codebook as described in embodiments 1-4.

Furthermore, as shown in FIG. 11, the base station 1100 may further include a transceiver 220, and an antenna 230, etc. The above antenna 230 may be configured as the planar antenna array shown in FIG. 1 or 2. It should be appreciated that the base station 1100 does not necessarily include all the parts shown in FIG. 11, and furthermore, the base station 1100 may include parts not shown in FIG. 11, and the relevant art may be referred to.

It can be seen from the above embodiment that by determining a codebook used for radio frequency precoding and a codebook used for baseband precoding, hybrid precoding of a baseband and a radio frequency may be performed, which is suitable for application of a large-scale MIMO system, thereby achieving an effective tradeoff between a system performance and complexity.

### Embodiment 7

An embodiment of this disclosure provides a communication system. FIG. 12 is a schematic diagram of a structure of the communication system of the embodiment of this disclosure. As shown in FIG. 12, the communication system 1200 includes a base station 1201 and user equipment 1202.

The base station 1201 is configured with the apparatus 900 or 1000 for determining a codebook as described in Embodiment 5. And the base station 1201 may carry out the methods for determining a codebook as described in embodiments 1-4.

In this embodiment, the base station 1201 has a planar antenna array including multiple antenna elements, the multiple antenna elements forming multiple columns in a vertical direction and forming multiple rows in a horizontal direction; wherein, the antenna elements in the same polarization direction in an antenna column in the vertical direction form one or more virtual antenna ports, the one or more virtual antenna ports being connected with multiple radio frequency chains.

An embodiment of the present disclosure provides a computer readable program code, which, when executed in a base station, will cause a computer unit to carry out the methods for determining a codebook as described in embodiments 1-4 in the base station.

An embodiment of the present disclosure provides a computer readable medium, including a computer readable program code, which will cause a computer unit to carry out the methods for determining a codebook as described in embodiments 1-4 in a base station.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof. And they may also be realized as a combination of computing equipment, such as a combination of a DSP and a microprocessor, multiple processors, one or more microprocessors in communication combination with a DSP, or any other such configuration.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. A method for determining a codebook, applicable to a planar antenna array including multiple antenna elements, the multiple antenna elements forming multiple columns in a vertical direction and forming multiple rows in a horizontal direction, the method for determining a codebook comprising:
determining a first codebook used for radio frequency precoding on the basis of the number of the antenna elements in the planar antenna array and/or the number of radio frequency chains; wherein, the antenna elements in the same polarization direction in an antenna column in the vertical direction form one or more virtual antenna ports, the one or more virtual antenna ports being connected with multiple radio frequency chains; and
determining a second codebook used for baseband precoding on the basis of the number of the antenna elements in the planar antenna array and/or the number of the radio frequency chains.

2. The method for determining a codebook according to claim 1, wherein each of the virtual antenna ports corresponds to multiple beams, and a product of the number of the virtual antenna ports and the number of the beams to which each of the virtual antenna ports corresponds is definite.

3. The method for determining a codebook according to claim 1, wherein the antenna elements in the same polarization direction in an antenna column in the vertical direction form a virtual antenna port, the virtual antenna port being connected with Q radio frequency chains;
in a case where the planar antenna array is of antenna configuration of same polarization, the first codebook is determined by using formula (1) below:
$${W}_{RF} = ( \begin{matrix}X & … & 0 \\ ⋮ & ⋱ & ⋮ \\ 0 & … & X\end{matrix} ) ∈ {C}^{NM \times NQ} , \\ X = [ \begin{matrix}{b}_{1} & … & {b}_{Q}\end{matrix} ] ∈ {C}^{M \times Q} ; \qquad ( 1 )$$
where, W_{RF} denotes the first codebook, C denotes a complex set, N is the number of the antenna elements of a row in each polarization direction in the planar antenna array in the horizontal direction, M is the number of the antenna elements of a column in each polarization direction in the planar antenna array in the vertical direction, and b_{q} is a discrete Fourier transform vector, q=1, 2, . . . Q;
and the second codebook is determined by using formula (2) below:
W_{BB}=AB,AεC^{NQ×N},BεC^{N×N}^{_{S}},
A=(E_{q,1} . . . E_{q,N})^{T},E_{q,n}εR^{Q×N} (2);
where, W_{BB} denotes the second codebook, R denotes a real number set, a matrix B denotes a precoding matrix of an actual antenna port, Ns is the number of data streams supported by the baseband, and E_{q,n} denotes a matrix with only elements at a q-th row and an n-th column being 1 and other elements being 0, n=1, 2, . . . N.

4. The method for determining a codebook according to claim 3, wherein b₁, b₂, . . . b_{Q} are orthogonal to each other, or b₁, b₂, . . . b_{Q} correspond to neighboring beams.

5. The method for determining a codebook according to claim 1, wherein the antenna elements in the same polarization direction in an antenna column in the vertical direction form a virtual antenna port, the virtual antenna port being connected with Q radio frequency chains;
in a case where the planar antenna array is of antenna configuration of cross polarization, the first codebook is determined by using formula (3) below:
$${W}_{RF} = ( \begin{matrix}X & … & 0 \\ ⋮ & ⋱ & ⋮ \\ 0 & … & X\end{matrix} ) ∈ {C}^{2 NM \times 2 NQ} , \\ X = [ \begin{matrix}{b}_{1} & … & {b}_{Q}\end{matrix} ] ∈ {C}^{M \times Q} ; \qquad ( 3 )$$
where, W_{RF} denotes the first codebook, C denotes a complex set, N is the number of the antenna elements of a row in each polarization direction in the planar antenna array in the horizontal direction, M is the number of the antenna elements of a column in each polarization direction in the planar antenna array in the vertical direction, and b_{q} is a discrete Fourier transform vector, q=1, 2, . . . Q;
and the second codebook is determined by using formula (4) below:
W_{BB}=AB,AεC^{2NQ×N}BεC^{2N×N}^{_{S}},
A=(E_{q,1} . . . E_{q,N})^{T},E_{q,n}εR^{Q×2N} (4);
where, W_{BB} denotes the second codebook, R denotes a real number set, a matrix B denotes a precoding matrix of an actual antenna port, Ns is the number of data streams supported by the baseband, and E_{q,n} denotes a matrix with only elements at a q-th row and an n-th column being 1 and other elements being 0, n=1, 2, . . . N.

6. The method for determining a codebook according to claim 1, wherein the antenna elements in the same polarization direction in an antenna column in the vertical direction form T=Q/l virtual antenna ports, the T virtual antenna ports being connected with Q radio frequency chains;
in a case where the planar antenna array is of antenna configuration of same polarization, the first codebook is determined by using formula (5) below:
$${W}_{RF} = ( \begin{matrix}X & … & 0 \\ ⋮ & ⋱ & ⋮ \\ 0 & … & X\end{matrix} ) ∈ {C}^{NM \times NQ} , \\ X = ( \begin{matrix}P & … & 0 \\ ⋮ & ⋱ & ⋮ \\ 0 & … & P\end{matrix} ) ∈ {C}^{M \times Q} , \\ P = [ \begin{matrix}{p}_{1} & … & {p}_{l}\end{matrix} ] ∈ {C}^{\frac{M}{T} \times l} ; \qquad ( 5 )$$
where, W_{RF} denotes the first codebook, C denotes a complex set, N is the number of the antenna elements of a row in each polarization direction in the planar antenna array in the horizontal direction, M is the number of the antenna elements of a column in each polarization direction in the planar antenna array in the vertical direction, each virtual antenna port corresponding to M/T antenna elements and being connected with l radio frequency chains, l=1, 2, . . . Q, and pᵢ is a discrete Fourier transform vector, i=1, 2, . . . l;
and the second codebook is determined by using formula (6) below:
$${W}_{BB} = AB , A ∈ {C}^{NQ \times NT} , B ∈ {C}^{NT \times {N}_{S}} , \\ A = ( \begin{matrix}{e}_{q} & 0 & … & 0 \\ 0 & {e}_{q} & ⋮ & 0 \\ ⋮ & ⋮ & ⋱ & ⋮ \\ 0 & 0 & … & {e}_{q}\end{matrix} ) ∈ {C}^{NQ \times NT} ; \qquad ( 6 )$$
where, W_{BB} denotes the second codebook, a matrix B denotes a precoding matrix of an actual antenna port, Ns is the number of data streams supported by the baseband, and e_{q} is a unit vector of
$$\frac{Q}{T} \times 1 ,$$
a q-th element being 1 and all other elements being 0.

7. The method for determining a codebook according to claim 1, wherein the antenna elements in the same polarization direction in an antenna column in the vertical direction form T=Q/l virtual antenna ports, the T virtual antenna ports being connected with Q radio frequency chains;
in a case where the planar antenna array is of antenna configuration of cross polarization, the first codebook is determined by using formula (7) below:
$${W}_{RF} = ( \begin{matrix}X & … & 0 \\ ⋮ & ⋱ & ⋮ \\ 0 & … & X\end{matrix} ) ∈ {C}^{2 NM \times 2 NQ} , \\ X = ( \begin{matrix}P & … & 0 \\ ⋮ & ⋱ & ⋮ \\ 0 & … & P\end{matrix} ) ∈ {C}^{M \times Q} , \\ P = [ \begin{matrix}{p}_{1} & … & {p}_{l}\end{matrix} ] ∈ {C}^{\frac{M}{T} \times l} ; \qquad ( 7 )$$
where, W_{RF} denotes the first codebook, C denotes a complex set, N is the number of the antenna elements of a row in each polarization direction in the planar antenna array in the horizontal direction, M is the number of the antenna elements of a column in each polarization direction in the planar antenna array in the vertical direction, each virtual antenna port corresponding to M/T antenna elements and being connected with l radio frequency chains, l=1, 2, . . . Q, and pᵢ is a discrete Fourier transform vector, i=1, 2, . . . l;
and the second codebook is determined by using formula (8) below:
$${W}_{BB} = AB , A ∈ {C}^{2 NQ \times 2 NT} , B ∈ {C}^{2 NT \times {N}_{S}} , \\ A = ( \begin{matrix}{e}_{q} & 0 & … & 0 \\ 0 & {e}_{q} & ⋮ & 0 \\ ⋮ & ⋮ & ⋱ & ⋮ \\ 0 & 0 & … & {e}_{q}\end{matrix} ) ∈ {C}^{2 NQ \times 2 NT} ; \qquad ( 8 )$$
where, W_{BB} denotes the second codebook, a matrix B denotes a precoding matrix of an actual antenna port, Ns is the number of data streams supported by the baseband, and e_{q} is a unit vector of
$$\frac{Q}{T} \times 1 ,$$
a q-th element being 1 and all other elements being 0.

8. The method for determining a codebook according to claim 1, wherein the method further comprises:
grouping the virtual antenna ports, and supporting multiple pieces of user equipment by using the grouped virtual antenna ports.

9. The method for determining a codebook according to claim 8, wherein the method further comprises:
grouping the virtual antenna ports according to down tilt angle distribution of the multiple pieces of user equipment, or grouping the virtual antenna ports according to the number of down tilt angles of the multiple pieces of user equipment.

10. An apparatus for determining a codebook, applicable to a planar antenna array including multiple antenna elements, the multiple antenna elements forming multiple columns in a vertical direction and forming multiple rows in a horizontal direction, the apparatus for determining a codebook comprising:
a first determining unit configured to determine a first codebook used for radio frequency precoding on the basis of the number of the antenna elements in the planar antenna array and/or the number of radio frequency chains; wherein, the antenna elements in the same polarization direction in an antenna column in the vertical direction form one or more virtual antenna ports, the one or more virtual antenna ports being connected with multiple radio frequency chains; and
a second determining unit configured to determine a second codebook used for baseband precoding on the basis of the number of the antenna elements in the planar antenna array and/or the number of the radio frequency chains.

11. The apparatus for determining a codebook according to claim 10, wherein each of the virtual antenna ports corresponds to multiple beams, and a product of the number of the virtual antenna ports and the number of the beams to which each of the virtual antenna ports corresponds is definite.

12. The apparatus for determining a codebook according to claim 10, wherein the antenna elements in the same polarization direction in an antenna column in the vertical direction form a virtual antenna port, the virtual antenna port being connected with Q radio frequency chains;
in a case where the planar antenna array is of antenna configuration of same polarization, the first codebook is determined by using formula (1) below:
$${W}_{RF} = ( \begin{matrix}X & … & 0 \\ ⋮ & ⋱ & ⋮ \\ 0 & … & X\end{matrix} ) ∈ {C}^{NM \times NQ} , \\ X = [ \begin{matrix}{b}_{1} & … & {b}_{Q}\end{matrix} ] ∈ {C}^{M \times Q} ; \qquad ( 1 )$$
where, W_{RF} denotes the first codebook, C denotes a complex set, N is the number of the antenna elements of a row in each polarization direction in the planar antenna array in the horizontal direction, M is the number of the antenna elements of a column in each polarization direction in the planar antenna array in the vertical direction, and b_{q} is a discrete Fourier transform vector, q=1, 2, . . . Q;
and the second codebook is determined by using formula (2) below:
W_{BB}=AB,AεC^{NQ×N},BεC^{N×N}^{_{S}},
A=(E_{q,1} . . . E_{q,N})^{T},E_{q,n}εR^{Q×N} (2);
where, W_{BB} denotes the second codebook, R denotes a real number set, a matrix B denotes a precoding matrix of an actual antenna port, Ns is the number of data streams supported by the baseband, and E_{q,n} denotes a matrix with only elements at a q-th row and an n-th column being 1 and other elements being 0, n=1, 2, . . . N.

13. The apparatus for determining a codebook according to claim 10, wherein the antenna elements in the same polarization direction in an antenna column in the vertical direction form a virtual antenna port, the virtual antenna port being connected with Q radio frequency chains;
in a case where the planar antenna array is of antenna configuration of cross polarization, the first codebook is determined by using formula (3) below:
$${W}_{RF} = ( \begin{matrix}X & … & 0 \\ ⋮ & ⋱ & ⋮ \\ 0 & … & X\end{matrix} ) ∈ {C}^{2 NM \times 2 NQ} , \\ X = [ \begin{matrix}{b}_{1} & … & {b}_{Q}\end{matrix} ] ∈ {C}^{M \times Q} ; \qquad ( 3 )$$
where, W_{RF} denotes the first codebook, C denotes a complex set, N is the number of the antenna elements of a row in each polarization direction in the planar antenna array in the horizontal direction, M is the number of the antenna elements of a column in each polarization direction in the planar antenna array in the vertical direction, and b_{q} is a discrete Fourier transform vector, q=1, 2, . . . Q;
and the second codebook is determined by using formula (4) below:
W_{BB}=AB,AεC^{2NQ×N},BεC^{2N×N}^{_{S}},
A=(E_{q,1} . . . E_{q,N})^{T},E_{q,n}εR^{Q×2N} (4);
where, W_{BB} denotes the second codebook, R denotes a real number set, a matrix B denotes a precoding matrix of an actual antenna port, Ns is the number of data streams supported by the baseband, and E_{q,n} denotes a matrix with only elements at a q-th row and an n-th column being 1 and other elements being 0, n=1, 2, . . . N.

14. The apparatus for determining a codebook according to claim 10, wherein the antenna elements in the same polarization direction in an antenna column in the vertical direction form T=Q/l virtual antenna ports, the T virtual antenna ports being connected with Q radio frequency chains;
in a case where the planar antenna array is of antenna configuration of same polarization, the first codebook is determined by using formula (5) below:
$${W}_{RF} = ( \begin{matrix}X & … & 0 \\ ⋮ & ⋱ & ⋮ \\ 0 & … & X\end{matrix} ) ∈ {C}^{NM \times NQ} , \\ X = ( \begin{matrix}P & … & 0 \\ ⋮ & ⋱ & ⋮ \\ 0 & … & P\end{matrix} ) ∈ {C}^{M \times Q} , \\ P = [ \begin{matrix}{p}_{1} & … & {p}_{l}\end{matrix} ] ∈ {C}^{\frac{M}{T} \times l} ; \qquad ( 5 )$$
where, W_{RF} denotes the first codebook, C denotes a complex set, N is the number of the antenna elements of a row in each polarization direction in the planar antenna array in the horizontal direction, M is the number of the antenna elements of a column in each polarization direction in the planar antenna array in the vertical direction, each virtual antenna port corresponding to M/T antenna elements and being connected with l radio frequency chains, l=1, 2, . . . Q, and pᵢ is a discrete Fourier transform vector, i=1, 2, . . . l;
and the second codebook is determined by using formula (6) below:
$${W}_{BB} = AB , A ∈ {C}^{NQ \times NT} , B ∈ {C}^{NT \times {N}_{S}} , \\ A = ( \begin{matrix}{e}_{q} & 0 & … & 0 \\ 0 & {e}_{q} & ⋮ & 0 \\ ⋮ & ⋮ & ⋱ & ⋮ \\ 0 & 0 & … & {e}_{q}\end{matrix} ) ∈ {C}^{NQ \times NT} ; \qquad ( 6 )$$
where, W_{BB} denotes the second codebook, a matrix B denotes a precoding matrix of an actual antenna port, Ns is the number of data streams supported by the baseband, and e_{q} is a unit vector of
$$\frac{Q}{T} \times 1 ,$$
a q-th element being 1 and all other elements being 0.

15. The apparatus for determining a codebook according to claim 10, wherein the antenna elements in the same polarization direction in an antenna column in the vertical direction form T=Q/l virtual antenna ports, the T virtual antenna ports being connected with Q radio frequency chains;
in a case where the planar antenna array is of antenna configuration of cross polarization, the first codebook is determined by using formula (7) below:
$${W}_{RF} = ( \begin{matrix}X & … & 0 \\ ⋮ & ⋱ & ⋮ \\ 0 & … & X\end{matrix} ) ∈ {C}^{2 NM \times 2 NQ} , \\ X = ( \begin{matrix}P & … & 0 \\ ⋮ & ⋱ & ⋮ \\ 0 & … & P\end{matrix} ) ∈ {C}^{M \times Q} , \\ P = [ \begin{matrix}{p}_{1} & … & {p}_{l}\end{matrix} ] ∈ {C}^{\frac{M}{T} \times l} ; \qquad ( 7 )$$
where, W_{RF} denotes the first codebook, C denotes a complex set, N is the number of the antenna elements of a row in each polarization direction in the planar antenna array in the horizontal direction, M is the number of the antenna elements of a column in each polarization direction in the planar antenna array in the vertical direction, each virtual antenna port corresponding to M/T antenna elements and being connected with l radio frequency chains, l=1, 2, . . . Q, and pᵢ is a discrete Fourier transform vector, i=1, 2, . . . l;
and the second codebook is determined by using formula (8) below:
$${W}_{BB} = AB , A ∈ {C}^{2 NQ \times 2 NT} , B ∈ {C}^{2 NT \times {N}_{S}} , \\ A = ( \begin{matrix}{e}_{q} & 0 & … & 0 \\ 0 & {e}_{q} & ⋮ & 0 \\ ⋮ & ⋮ & ⋱ & ⋮ \\ 0 & 0 & … & {e}_{q}\end{matrix} ) ∈ {C}^{2 NQ \times 2 NT} ; \qquad ( 8 )$$
where, W_{BB} denotes the second codebook, a matrix B denotes a precoding matrix of an actual antenna port, Ns is the number of data streams supported by the baseband, and e_{q} is a unit vector of
$$\frac{Q}{T} \times 1 ,$$
a q-th element being 1 and all other elements being 0.

16. The apparatus for determining a codebook according to claim 10, wherein the apparatus further comprises:
a grouping unit configured to group the virtual antenna ports, and support multiple pieces of user equipment by using the grouped virtual antenna ports.

17. The apparatus for determining a codebook according to claim 16, wherein the grouping unit is configured to group the virtual antenna ports according to down tilt angle distribution of the multiple pieces of user equipment, or group the virtual antenna ports according to the number of down tilt angles of the multiple pieces of user equipment.

18. A communication system, comprising:
a base station having a planar antenna array including multiple antenna elements, the multiple antenna elements forming multiple columns in a vertical direction and forming multiple rows in a horizontal direction; wherein, the antenna elements in the same polarization direction in an antenna column in the vertical direction form one or more virtual antenna ports, the one or more virtual antenna ports being connected with multiple radio frequency chains;
wherein, the base station determines a first codebook used for radio frequency precoding on the basis of the number of the antenna elements in the planar antenna array and/or the number of radio frequency chains, and determines a second codebook used for baseband precoding on the basis of the number of the antenna elements in the planar antenna array and/or the number of the radio frequency chains.
